(19) United States
(12) Patent Application Publication
(10) Pub. No.: US 2007/0080504 A1
(43) Pub. Date: Apr. 12, 2007

(54) Compressed gas cylinder seal

(76) Inventor: Henry Buermann, Brookfield, VT (US)

Correspondence Address: Kevin Ellicott, Esq., Suite 112, 1 Scale Ave., Rutland, VT, 05701, US

(21) Appl. No.: 11/244,784

(22) Filed: Oct. 6, 2005

(51) Int. Cl. F16L 17/06

(52) U.S. Cl. 277/608

(57) ABSTRACT

A compressed gas cylinder valve seal comprising a top surface, a bottom surface and a circumferential skirt, a first concentric ridge on the top surface, a second concentric ridge on the top surface, a third concentric ridge on the bottom surface, a fourth concentric ridge on the bottom surface, a cylindrical center section extending upwardly and away from the top surface, the cylindrical center section having a cylindrical center section ridge, and a gas passageway extending completely through the seal for permitting the passage of liquid through the seal.

### CROSS REFERENCE TO OTHER APPLICATIONS

This is the first submission of an application for this article of manufacture. There are no other applications, provisional or non provisional.

### FEDERALLY SPONSORED RESEARCH AND DEVELOPMENT

There are no federally sponsored or funded research or development projects or undertakings in any way associated with the instant invention.

### BACKGROUND OF THE INVENTION

1. Field of the Invention:

The instant invention relates to that field of devices consisting of articles of manufacture known as seals. Specifically, the instant invention is a seal for use between a compressed gas regulator and a compressed gas cylinder valve.

2. Background Information:

The prior art known to the Inventors discloses that various forms of seals are well known throughout the arts.

These seals are generally incorporated whenever metal (or a similar stiff material) and metal (or similar stiff material) are to be brought into physical contact, for the purpose of preventing gas or liquid from escaping at the metal to metal junction.

In general, seals of the sort represented by the instant invention are utilized most frequently in conjunction with pressurized gas tanks. The seal is frequently provided along with the tanks and or regulators and may be found in close association with the tank. Often, the seal is held onto the tank valve by a dust cover or similar retention means (see for example U.S. Pat. No. X). The contents of pressurized gas tank are most often accessible through a valve that is attached to the tank. The valve, in turn, is often of the sort that has thereupon at least one gas passage means. It is this gas passage through which the pressurized contents of the tank is allowed to escape said tank. The valve further often includes means for attaching a regulator to the valve. In the sort of valve referred to herein, the means for attaching the regulator is a pair of blind holes, each having a bore, proximate to the gas passage means, and on the opposite side of the valve from said blind holes a dimple. The attachment of a regulator or similar device is most frequently accomplished by having the regulator itself removably connected to a valve clamping means which includes a retainer having a pair of pins and an opposite turnable screw, the turning of said screw pulling the regulator into contact with the valve gas passage means, while the pair of pins seat into the pair of blind holes, and both stabilize and guide the regulator into contact with the gas passage means.

The regulator is the means for measuring and metering the pressure and or volume of gas which is allowed to escape the pressurized tank. However, unless a seal is placed into the passage means before the regulator is attached, it is almost certain that pressurized gas will escape from between the regulator and the valve (most commonly the gas escaping through any nick or other slight deformation of the surfaces of the regulator which would contact the valve, and the valve gas passage).

Once the seal has been laid into the passage means, one must then “seat” the regulator into the valve. This is usually accomplished by twisting the screw found on the valve clamping means sufficiently so that the regulator is pressed firmly against the seal and the opposite side of the seal is pressed firmly against the valve passage means.

Unfortunately, in order to fully seat the regulator such that the seal can prevent the escape of any gas from between the valve and the regulator, most seals must be well compressed by the action of the regulator screw being twisted or turned enough times so that the mating surfaces of the regulator and the valve have sufficient contact against the seal.

While this does not present a great problem to most strong and healthy individuals, it can be a nearly impossible task for the elderly. And it is the elderly who quite frequently find themselves having to utilize the contents of pressurized gas tanks. For example, sufferers of emphysema are often elderly. And with their weakened condition and weakened (often arthritic) hands, securely seating the regulator into the valve is a daunting task which all too commonly results in an incomplete sealing. Such an incomplete sealing of the tank can lead to something as innocuous as a constant but minor slow leak of the contents of the tank (in this case, oxygen), or something far more catastrophic, such as a large uncontrolled leak and potential uncontrolled combustion in the vicinity of the leaking tank (due to the accelerant properties of pressurized, pure, oxygen).

Furthermore, while the elderly are the most obviously at risk when it comes to seating a regulator into a valve, it is well recognized in the field of medical services delivery (i.e. hospitals and ambulances) that during the rapid change over of a regulator from an empty tank to a full one in hectic trauma surrounded circumstances, it is not an uncommon event to have a regulator not fully or properly seated onto a pressurized gas tank. This can result in both the loss of valuable resources (the pressurized gas) and the potential for injuries.

The state of the art, then, is a situation where those who use pressurized gas tanks would prefer to have a seal which was at once strong enough to withstand the force of the gas trying to escape around it, but at the same time would be amenable to seating with less effort than the seals currently manufactured.

It is further recognized within the art that one should ideally be able to place the seal against the valve passage means, and then be able to release it from one's grasp or to remove the dust cover under which the seal is often placed without fear that the seal will fall away from the valve under the force of gravity while one clamps the regulator onto the valve. Without such an ability, the installation of the seal and then the regulator becomes an activity requiring at least two hands. Worse still, given that pressurized gas tanks such as those containing oxygen are often used by individuals having poor motor skills (the elderly) and those operating under crisis conditions (emergency room or ambulance personnel), it is not at all uncommon for the user of the seal to mishandle and or drop it. Where installation of a regulator into a pressurized gas tank is a matter of life or death, having that seal stay in place once pushed against the valve can be a critical concern. Unfortunately, the art currently provides for no seal which will both stay in place when applied, and seat with less effort during the process of attaching the regulator to the valve.

An additional problem which the instant invention remedies occurs frequently when the dust cover is being removed from an unused tank or cylinder during an emergency situation where stress may have decreased the user's dexterity. This is frequently the case where an ambulance arrives at an accident or other trauma site, and the first responders are trying to set up an unused oxygen cylinder. With the current state of the art seals, it is a well known problem that as the dust cover is pulled from the valve, the lose seal being held by the dust cover may fall on the ground. Once on the ground, it may become contaminated by dirt and debris and thus never seat properly into the valve. However, by using the instant invention, the seal will be held onto the valve even as the dust cover is removed, nearly eliminating any chance that the seal will end up on the ground during the confusion and rapid movements of the first responders.

The inventor has created just such a seal which, by incorporating novel geometry and being manufactured from appropriate material, can be compressed in just the right manner to stay in place once pressed against the valve as well as allow the regulator to seat with far less effort than current seals, and yet still withstand the force of the pressurized gas attempting to escape from between the regulator and the valve. Once in place, it is generally self-retained, and a dust cover which is placed over it need only prevent the intrusion of dust and dirt, not have to serve the additional function of retaining the seal in place as well.

### SUMMARY OF THE INVENTION

The instant invention is a valve seal, principally for use with pressurized gas tanks. For the first time, it is possible to seat the regulator into the valve of a pressurized gas tank with minimal effort and yet obtain the assurance of a strong, positive seal which will minimize leakage and blow-by occurrences. And although the instant invention is generally referred to as being useful in connection with a pressurized gas tank, at the junction of the regulator and valve, it is entirely possible that it could be incorporated into myriad other situations where the contents of a container are under pressure, and a means for controllably withdrawing those pressurized contents is to be connected to the container. In any such situation where the container and withdrawing means have need for a seal at their interface, the instant invention may be superior to current, state of the art seals, without departing from the scope of the claims.

A first object of the instant invention, therefore, is to provide for a seal which will allow positive seating of the regulator into the valve passage means.

This objective is accomplished by fabricating a seal from appropriate materials which are somewhat flexible, yet strong enough to withstand the pressure of tank contents against it.

A second object of the instant invention is to provide for a seal which will allow positive seating of the regulator into the valve passage means without requiring the application of a great deal of force to the regulator clamping mechanism while installing it onto the valve.

This objective is accomplished by fabricating a seal from appropriate materials which are somewhat flexible, yet strong enough to withstand the pressure of tank contents against it and which will deform in a controlled and expected manner as the regulator is installed against the valve, thereby creating a positive seal.

A third object of the instant invention is to provide for a seal which will stay in place once pressed against the valve, thus allowing for removal of one's hands so that both hands become available to be used in the process of attaching the regulator to the valve.

This objective is accomplished by fabricating a seal from appropriate materials which are somewhat flexible, the seal having a portion which is essentially a cylindrical and having at least one ridge, sized to extend slightly into the valve and deform when pressed against, the cylindrical section with ridge then behaving much as a biasing means to keep the seal fixed in place while attaching the regulator.

### A DESCRIPTION OF THE DRAWINGS

FIG. 1 is a close up perspective view of a pressurized gas tank valve.

FIG. 2 is an elevational view of a typical regulator and yoke.

FIG. 3 is a close-up cross-sectional view a pressurized gas tank valve's passage means with the instant invention in place.

FIG. 4 is an elevational cross sectional view of the instant invention.

FIG. 5 is a perspective view of the instant invention.

FIG. 6 is a side elevational view of a portion of the instant invention.

FIG. 7 is a close up side elevational view of a portion of the instant invention.

FIG. 9 is a close up elevational view of the instant invention engaged with the valve and the regulator gas passage means.

FIG. 10 is a close up elevational view of the instant invention.

FIG. 11 is a close up elevational view of a portion of the instant invention and the regulator gas passage means and the valve.

FIG. 12 is an overhead view of a portion of the instant invention.

FIG. 13 is an overhead view of a portion of the instant invention engaged with the regulator valve.

### A DESCRIPTION OF THE PREFERRED EMBODIMENT

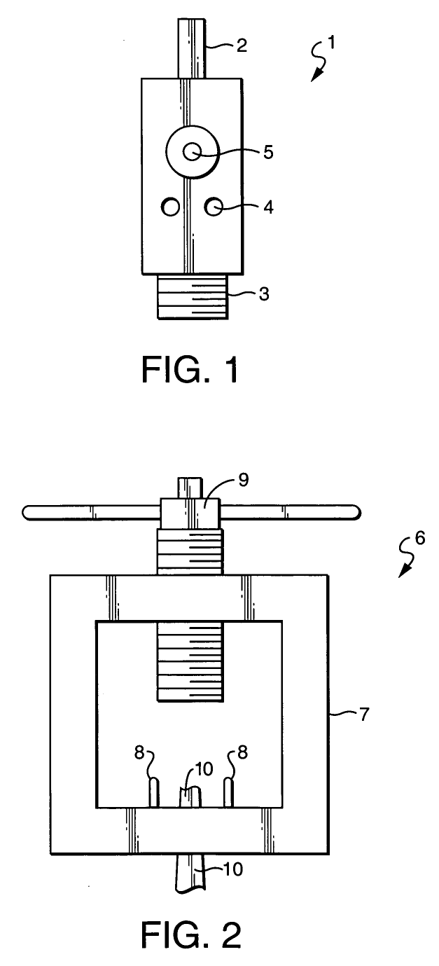

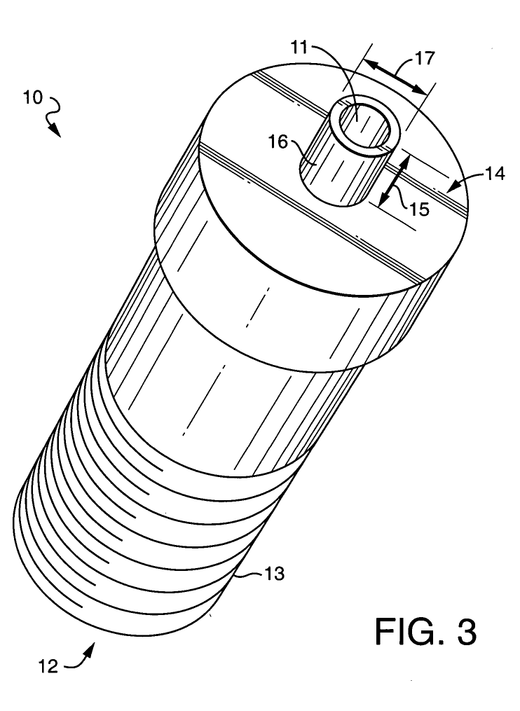

As per FIGS. 1 and 2, in the preferred embodiment a seal is constructed for use on a container of liquid or gas under pressure, the container generally being a cylinder. Such a cylinder will include a valve (1), the valve having a shut-off mechanism (2) and a threaded portion (3) for threadably engaging with and attaching to the cylinder.

The valve (1) of the sort referenced herein will also usually include a pair of holes, each hole having a blind bore (4). The valve will further usually include a gas passage means (5). The gas passage means is usually a hole communicating through the hollow interior of the valve, to the interior of the cylinder.

The container will also generally use a regulator to meter out and allow the escape from the container, in a controlled manner, the liquid or gas within the container. These regulators come in a wide variety of shapes and sizes, and the particular regulator used will be a function of choice or necessity driven by the requirements of whatever or whomever will consume the contents of the container. However, in order to provide a clear understanding of the invention, one particular form of regulator will be generally described. In this sort of regulator, attachment of the regulator to the valve is accomplished through the use of a valve clamping means (6), also known as a yoke, which includes a frame work acting as a retainer (7) having a pair of pins (8) and an opposite turnable screw (9), the turning of said screw pulling a regulator gas passage means (10) into contact with the valve gas passage means (5), while the pair of pins (8) seats into the pair of blind holes (4), both stabilizing and guiding the regulator gas passage means (10) into contact with the valve gas passage means (5).

What has been described thus far would be well known to anyone familiar with the art, and is presented merely to enable clear understanding of the detailed description of the seal, which follows. However, before describing the instant invention, it is useful to provide a still more detailed description of the prior art valve gas passage means (5) and the regulator gas passage means (10).

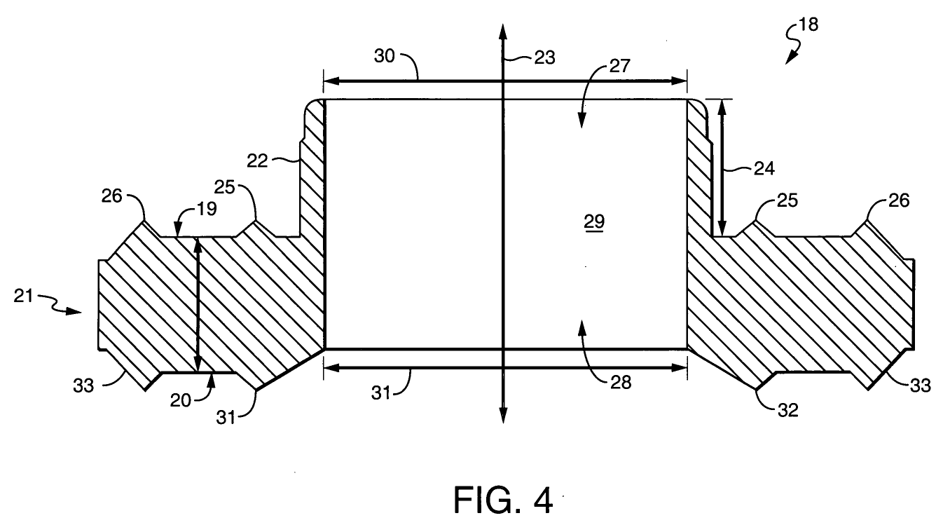

In the example described thus far, the regulator includes a regulator gas passage means (10). As per FIG. 3, this is usually a hollow stem having a gas passage nipple (16), the gas passage nipple having extending therethrough a first gas passage opening (11) at one end and a second gas passage opening (12) at the opposite end and having threads (13) proximate to one end for permitting attachment to the regulator. The regulator gas passage means (10) usually includes a shoulder area (14) which is a flat area surrounding the first gas passage nipple (16). The first gas passage nipple is generally centered on the shoulder area (14) and extends upwardly and away from the shoulder area. The distance the first gas passage nipple extends upwardly and away from the shoulder area may be referred to as the first gas passage nipple height (15).

As gas must pass through the gas passage nipple, it clearly is also hollow. The gas passage nipple outside diameter (17) is therefore greater than the diameter of the gas passage opening (11).

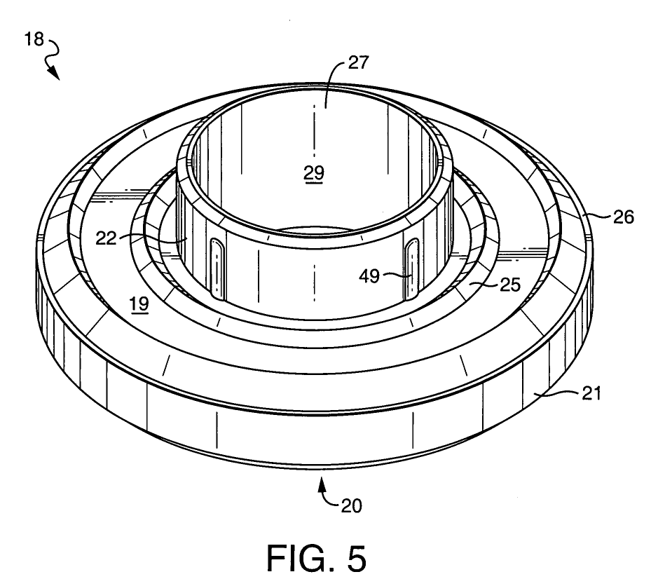

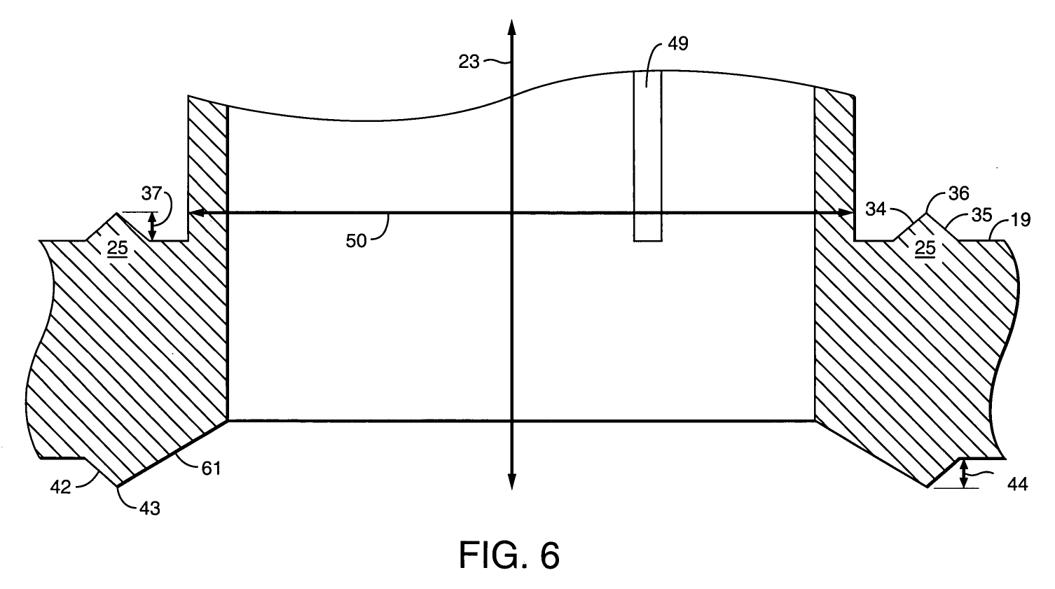

The instant invention, as per FIGS. 4 and 5 is a seal (18) preferably for use with gas cylinders of the sort having contents under high pressure and which use a valve and regulator to release the contents in a controlled manner.

The seal (18) is generally discoidal, having a top surface (19), an opposite bottom surface (20) and a circumferential skirt (21). The top surface and the bottom surface each merge into the skirt around the entire circumference of the seal. The seal further has a number of concentric ridges and a cylindrical center section. In the preferred embodiment, the cylindrical center section (22) is located at the center axis (23) of the seal and extends upwardly and away from the top surface (19). The cylindrical center section has height (24), and that height is dependant upon the requirements of the particular valve/regulator combination. However, in the preferred embodiment, where the first gas passage nipple height is 0.125 inch, the cylindrical center section height is 0.098 inch. It will be noted that the cylindrical center section height (24) is greater than the first gas passage nipple height (15). This is because it is believed that the invention functions most efficiently when the cylindrical center section extends into the valve gas passage means (5) slightly further than the first gas passage nipple. It is believed that the instant invention operates best when the center section height (24) is as great as possible, yet not so great as to interfere with the operation of the valve mechanism itself. It is also believed that having the gas passage nipple height somewhat shorter than the center section height further ensures that the gas passage nipple will not interfere with the operation of the valve mechanism. The seal further includes a first concentric ridge (25). The first concentric ridge is found on the seal top surface (19), extending upwardly and away from the top surface as does the cylindrical center section (22). The first concentric ridge has the form of a ring, surrounding the cylindrical center section, the radial distance between the cylindrical center section and the first concentric ridge preferably being approximately 0.179 inch.

The seal further includes a second concentric ridge (26). The second concentric ridge is found on the seal top surface (19), extending upwardly and away from the top surface as does the cylindrical center section (22) and the first concentric ridge (25). The second concentric ridge has the form of a ring, surrounding the cylindrical center section, the radial distance between the cylindrical center section and the second concentric ridge preferably being approximately 0.259 inch, the second concentric ridge obviously being spaced apart from the first concentric ridge (25).

As per FIGS. 4 and 5, the seal includes a first gas passage opening (27) passing through the cylindrical center section (22) and a second gas passage opening (28) passing through the bottom surface (20). The seal first gas passage opening and the seal second gas passage opening are coextensive with one another and coaxial with one another and the center axis (23), thus together forming a seal gas passageway (29), such that fluid may enter the seal first gas passage opening, pass completely through the seal (via the seal gas passageway), and exit through the seal second gas passage opening. When the seal is in place, and the regulator is fully attached to the valve, gas under pressure may escape the container through the valve, passing through the seal, and into the regulator.

In the preferred embodiment, the seal first gas passage opening (27) has a diameter (30), and the seal second gas passage opening has a diameter (31). However, the precise diameter of the first gas passage opening and the second gas passage opening may be varied according to the needs of the particular valve and the particular regulator being used without departing from the scope of the claims. It is preferred that the seal second gas passage opening diameter (31) be greater than the seal first gas passage opening diameter because of the configuration of the concentric ridges, as explained below. In particular, the larger diameter of the seal second gas passage opening assists in centering and inserting the gas passage nipple (16), when assembling the valve, seal and regulator together.

The seal further includes a third concentric ridge (32). The third concentric ridge is found on the seal bottom surface (20), extending downwardly and away from the bottom surface, opposite the direction which the cylindrical center section (22) extends away from the top surface (19). The third concentric ridge has the form of a ring, surrounding the second gas passage opening (28), the radial distance between the a second gas passage opening and the third concentric ridge preferably being approximately 0.179 inch.

Finally, the seal further includes a fourth concentric ridge (33). The fourth concentric ridge is found on the seal bottom surface (20), extending downwardly and away from the bottom surface, as does the third concentric ridge (32) and opposite the direction which the cylindrical center section (22) extends away from the top surface (19). The fourth concentric ridge has the form of a ring, surrounding the second gas passage opening (28), the radial distance between the second gas passage opening and the fourth concentric ridge preferably being approximately 0.259 inch, the fourth concentric ridge obviously being spaced apart from the third concentric ridge (32).

Have set forth the general arrangement of the seal, and having described with reasonable specificity the concentric ridges, it is useful to provide a more detailed description of the concentric ridges, and how they cooperate to provide a more reliable and safer seal than was available in the past.

As per FIGS. 4, 5, and 6, the first concentric ridge (25) may be more particularly described as being composed of a first angled surface (34) and a second angled surface (35). The first angled surface and the second angled surface angle towards one another such that they meet at the first concentric ridge peak (36). Taking the seal center axis (23) as being at 0 (zero) degrees relative to itself, the first ridge first angled surface (34) is preferably at an angle of 50 degrees relative to the center axis, and the first ridge second angled surface (35) is at an angle of 50 degrees relative to the center axis (23). The first concentric ridge height (37), that is, the vertical distance between the top surface (19) and the first concentric ridge peak (36), is preferably 0.012 inch.

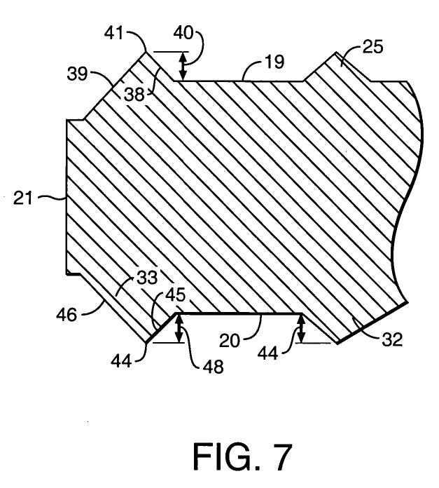

As per FIGS. 4, 5 and 7, the second concentric ridge (26) may be more particularly described as being composed of a first angled surface (38) and a second angled surface (39). The first angled surface and the second angled surface angle towards one another such that they meet at the second concentric ridge peak (41). Taking the seal center axis (23) as being at 0 (zero) degrees relative to itself, the second ridge first angled surface (38) is preferably at an angle of 45 degrees relative to the center axis, and the second ridge second angled surface (39) is at an angle of 45 degrees relative to the center axis (23). The second concentric ridge height (40), that is, the vertical distance between the top surface (10) and the second concentric ridge peak (39) is preferably 0.012 inch.

As per FIGS. 4, 5 and 6, the third concentric ridge (32) may be more particularly described as being composed of a first angled surface (61) and a second angled surface (42). The first angled surface and the second angled surface angle towards one another such that they meet at a third concentric ridge peak (43). Taking the seal center axis (23) as being at 0 (zero) degrees relative to itself, the third ridge first angled surface (61) is preferably at an angle of 60 degrees relative to the center axis, and the third ridge second angled surface (42) is at an angle of 50 degrees relative to the center axis (23). The third concentric ridge height (44), that is, the vertical distance between the seal bottom surface (20) and the third concentric ridge peak (44) is preferably 0.012 inch.

Finally, as per FIGS. 4, 5 and 7, the fourth concentric ridge (33) may be more particularly described as being composed of a first angled surface (45) and a second angled surface (46). The first angled surface and the second angled surface angle towards one another such that they meet at a fourth concentric ridge peak (47). Taking the seal center axis (23) as being at 0 (zero) degrees relative to itself, the fourth ridge first angled surface (45) is preferably at an angle of 45 degrees relative to the center axis, and the fourth ridge second angled surface (46) is at an angle of 45 degrees relative to the center axis (23). The fourth concentric ridge height (48), that is, the vertical distance between the seal bottom surface (20) and the fourth concentric ridge peak (47) is preferably 0.012 inch.

It should be obvious that when discussing the angled surfaces, in each case where there is a first angled surface and a second angled surface, they incline such that they meet at the ridge peak. So when considering an angle of 45 degrees on the first angled surface and an angle of 45 degrees on the second angled surface, with both being defined relative to the center axis, the measurement of the second angled surface must be considered as being taken 180 degrees around the concentric ring, directly opposite where the measurement of the first angled surface was taken.

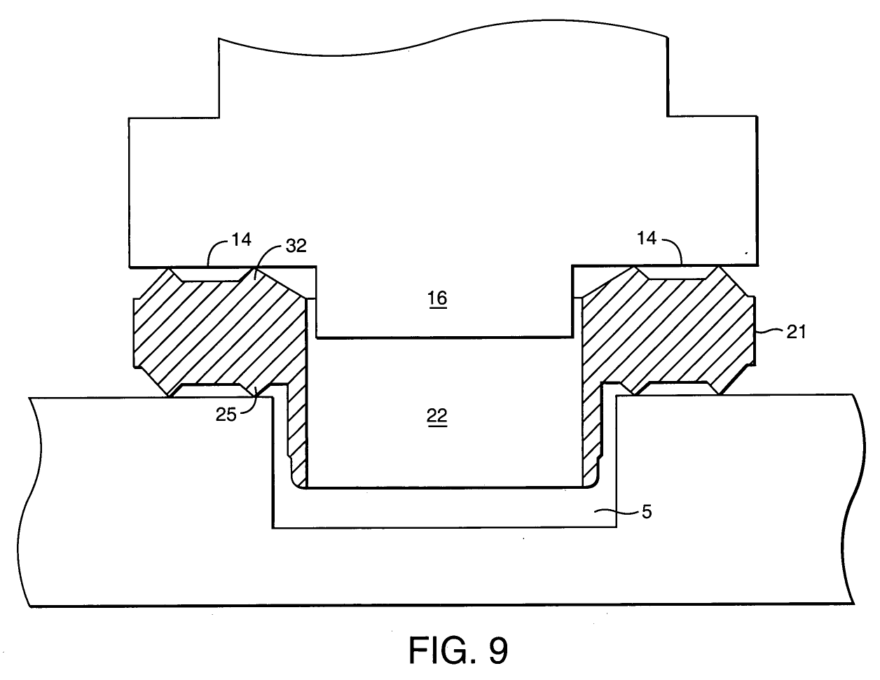

As per FIGS. 4, 6, 7, 8, 9 and 10, the seal is designed so that the third ridge first angled surface (61) serves as a beveled surface, facilitating easy insertion of the gas passage nipple (16) into the a seal gas passageway (29) during assembly of the valve, seal and regulator. However, while the angle of the third ridge first angled surface facilitates assembly, its configuration, like the configuration of the other concentric ridges, serves to improve the quality of the sealing of the regulator to the valve.

In particular, it has been learned that when the seal is constructed from nylon, when the seal is placed between the regulator and the valve and the regulator is tightened onto the valve (in the example at hand, by turning the screw (9)), the concentric ridges tend to deform, permitting the seal top surface (19) to come into full contact with the valve (1) and the seal bottom surface (20) to come into full contact with the regulator gas passage means shoulder area (14), thus sealing the regulator to the valve. The ridges then, in part because of the malleability of the material from which the seal is fabricated and in part because of the novel design of the ridges themselves, tend to deform or flatten out when pressed tightly between the regulator and the valve, tend to flatten out somewhat, providing an additional amount of material between the valve and the regulator which further inhibits the uncontrolled escape of high pressure contents between the regulator and the valve. That is, the seal literally flows somewhat, conforming to the surface geometry of the sealing surfaces of the regulator and valve, and filling in micro-fissures, dings, and other similar minor surface imperfections, further contributing to a firm seal between the regulator and valve.

Not only do the concentric ridges themselves play a hugely important role in the performance of the seal, but the angled surfaces of each ridge is of great importance. If the ridges were merely vertical walled protuberances extending from the top surface and the bottom surface of the seal, they would require considerably more clamping pressure by the valve clamping means (6) in order to firmly seat the regulator into the valve and prevent the undesired escape of high pressure material between the valve and the regulator.

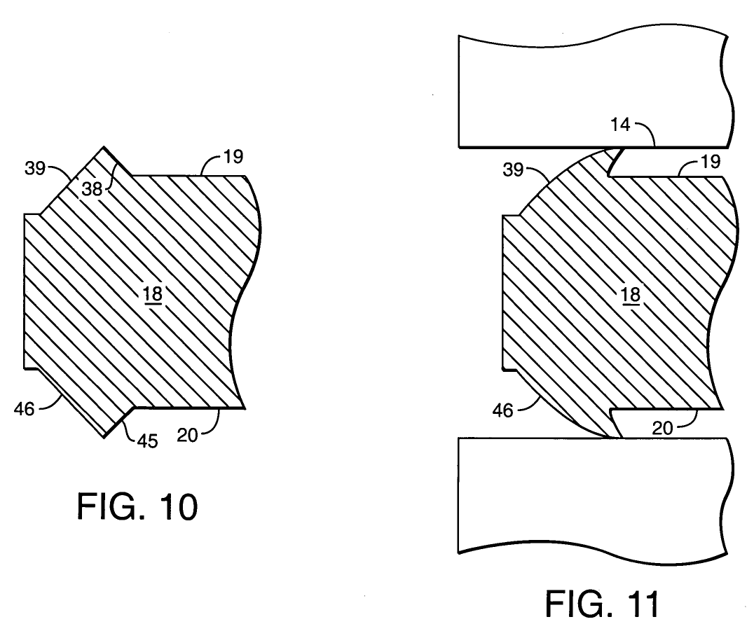

The ridges have angled surfaces precisely to reduce the clamping pressure required in order to seat the regulator, and have the seal perform optimally. As per FIGS. 10 and 11, it is readily apparent that the second concentric ridge first angled surface (38) is at a much steeper angle when compared to the second concentric ridge second angled surface (39). So too, the fourth concentric ridge first angled surface is at a steeper angle when compared to the fourth concentric ridge second angled surface. As per FIG. 11, when the seal is in place between the regulator and the valve, and the valve clamping means is tightened so that the seal is compressed between the valve and the regulator gas passage means shoulder area (14), the second concentric ridge and the fourth concentric ridge will tend to flatten out, until at last the ridges merge into the top surface and the bottom surface. At that point, the seal is completely seated, and performs optimally.

Obviously while only the second concentric ridge and fourth concentric ridge were described as flattening out or deforming, the first concentric ridge and the third concentric ridge include angled surfaces and will be deformed in the same manner as the first and fourth concentric ridges.

And while very particular angles were provided for the angled surfaces of the concentric ridges, it should be entirely clear and obvious that these angles may be varied depending upon the strength of the seal which is desired, and the material which is used to fabricate the seal. Where a more malleable or more easily deformable material is to be used for the seal, it is entirely possible to, for example, decrease the angle of the second angled surface of the second concentric ridge. On the other hand, should a stiffer or less easily bendable or deformable material be desired, it will be preferable to further increase the angle of the second angled surface of the second concentric ridge. Such changes will be readily apparent now that this disclosure has been made, and those who routinely practice in the art will require little to no experimentation in order to vary the particular angles of the concentric ridge surfaces and fabricate from different materials. Furthermore, while the preferred embodiment of the instant invention incorporates a total of four concentric ridges, it will be glaringly apparent to routineers in the art that they can easily add more concentric ridges and vary their specific locations along the seal top surface (19) and the seal bottom surface (20) depending upon the seal desired. Reducing the number of ridges is also a simple and obvious matter, and the choice of four rather than two concentric ridges is believed to be the optimum minimum number of ridges. Obviously one could reduce the sealing capacity of the instant invention by removing one or more of the ridges, but the inventor prefers to disclose the best mode for practicing the invention, and not necessarily all inferior modes which are still covered by the claims. It will also be obvious to those skilled in the art that as per FIG. 4, the seal has seal thickness (55) which is essentially the distance between the seal top surface (19) and the seal bottom surface (20). In the preferred embodiment, the seal thickness is approximately 0.093 inch, however this may easily be varied according to the need of the user, and based upon the materials from which the instant invention is to be fabricated.

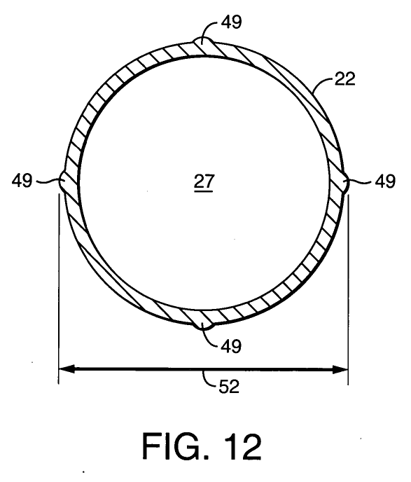

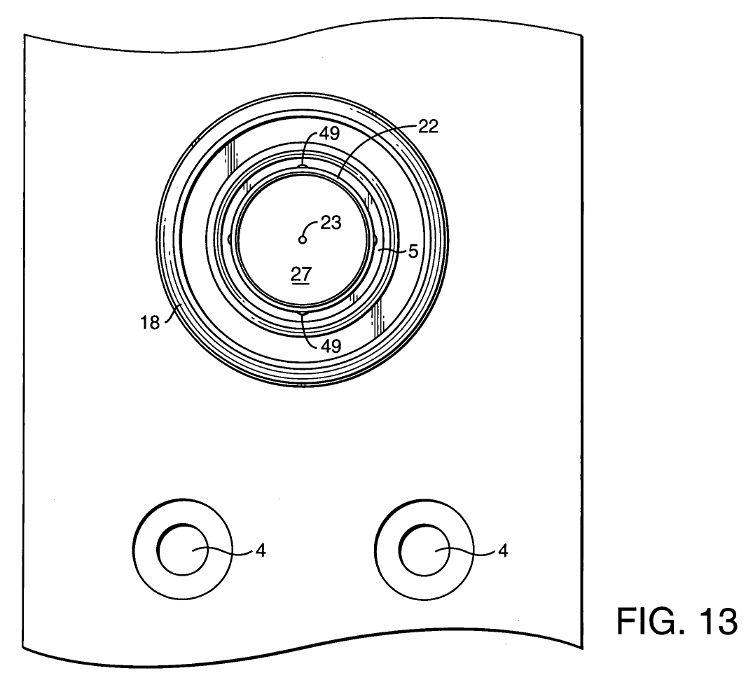

Finally, one of the objects of the invention stated early on is to have a seal which will remain in place while the regulator is assembled onto the valve. In the preferred embodiment, as per FIGS. 1, 5, 6, 9, 12 and 13, the instant invention includes at least one cylindrical center section ridge (49). The cylindrical center section ridge cooperates with the cylindrical center section to act as a biasing means and retain the seal in the valve while the regulator is assembled onto the valve.

In the preferred embodiment, there are at least 4 cylindrical center section ridges (49), oriented parallel to the seal center axis (23). These cylindrical center section ridges are located on the cylindrical center section, and are preferably evenly spaced circumferentially about it. The ridges extend outwardly, beyond the cylindrical center section such that when the seal is pushed against the valve so that the cylindrical center section enters the valve gas passage means (5) the cylindrical center section ridges contact valve gas passage means. The cylindrical center section (22) has a cylindrical center section outside diameter (50) which is only slightly less than an inside diameter (51) of the valve gas passage means. Normally, if the instant invention did not include the cylindrical center section ridges, the seal would be inclined to fall out under the force of gravity, during movement of the valve and regulator during assembly, or during removal of the dust cover prior to assembly of the regulator onto the valve. However, because the cylindrical center section (22) includes the cylindrical center section ridges (49), and because those ridges extend outwardly from the cylindrical center section and come into direct physical contact with the valve gas passage means, in order for the cylindrical center section of the seal to seat into the valve gas passage means, the cylindrical center section ridges must deform the cylindrical center section slightly towards the seal center axis (23). In other words, while the cylindrical center section outside diameter (50) is slightly less than the valve gas passage means inside diameter (51), the cylindrical center section ridge to opposite ridge diameter (52) is slightly greater than the valve gas passage means inside diameter (51). Therefore, in order to seat the seal into the valve, as per FIG. 13 the cylindrical center section ridges (49) must be urged towards the seal center axis (23). And as the seal is preferably made from a somewhat pliable and or malleable material such as nylon, the cylindrical center section will tend to try to regain it's original undeformed state, and thus act as a biasing means to retain the cylindrical center section within the valve gas passage means (5). The cylindrical center section ridges are really only slight protuberances arranged and radially spaced apart around the cylindrical center section, and their precise dimensions is largely dependant upon the material from which the seal is to be fabricated. In the preferred embodiment, the cylindrical center section ridge to opposite ridge diameter is approximately 0.295 inch. Should a stiffer, less easily deformable material be chosen for fabrication of the seal, the cylindrical center section ridges would likely require reduction in dimension and the cylindrical center section ridge to opposite ridge diameter would also likely decrease. So long as the cylindrical center section ridges cooperate with the cylindrical center section and valve gas passage means to retain the seal in contact with the valve, the precise dimensions of the cylindrical center section ridges, as well as the precise number of said ridges included on the instant invention, may be varied without departing from the scope of the invention.

I claim:

1. A compressed gas cylinder valve seal comprising:
A. a top surface, an opposite bottom surface and a circumferential skirt,
I. the top surface and the bottom surface each merging into the circumferential skirt around the entire circumference of the seal,
II. a cylindrical center section and a first concentric ridge,
a. the first concentric ridge being located on the top surface,
b. the cylindrical center section having a cylindrical center section ridge,
III. a gas passageway for permitting fluid to pass completely through the seal.

2. A compressed gas cylinder valve seal according to claim 1, further comprising:
A. a plurality of concentric ridges.

3. A compressed gas cylinder valve seal according to claim 1, further comprising;
A. a plurality of cylindrical center section ridges.

4. A compressed gas cylinder valve seal according to claim 1, further comprising;
A. a center axis,
B. the first concentric ridge having a first angled surface and a second angled surface,
I. the first angled surface being at an angle of 50 degrees relative to the center axis, angled away from the center axis,
II. the second angled surface being angled towards the center axis, at an angle equal to, but opposite the first angled surface such that the first angled surface and second angled surface extend towards one another and meet at a first concentric ridge peak.

5. A compressed gas cylinder valve seal according to claim 1, further comprising;
A. a center axis,
B. the first concentric ridge having a first angled surface and a second angled surface,
I. the first angled surface being at an angle of 50 degrees relative to the center axis, angled away from the center axis,
II. the second angled surface being at an angle equal to, but opposite the first angled surface such that the first angled surface and second angled surface extend towards one another and meet at a first concentric ridge peak.
C. a second concentric ridge,
I. the second concentric ridge having a first angled surface and a second angled surface,
a. the second concentric ridge first angled surface being at an angle of 45 degrees relative to the center axis, angling away from the center axis,
b. the second concentric ridge second angled surface being at an angle equal to, but opposite the first angled surface such that the first angled surface and second angled surface extend towards one another and meet at a second concentric ridge peak.

6. A compressed gas cylinder valve seal according to claim 1, further comprising;
A. a center axis,
B. the first concentric ridge having a first angled surface and a second angled surface,
I. the first angled surface being at an angle of approximately 50 degrees relative to the center axis, angled away from the center axis,
II. the second angled surface being at an angle equal to, but opposite the first angled surface such that the first angled surface and second angled surface extend towards one another and meet at a first concentric ridge peak.
C. a second concentric ridge,
I. the second concentric ridge having a first angled surface and a second angled surface,
a. the second concentric ridge first angled surface being at an angle of approximately 45 degrees relative to the center axis, angling away from the center axis,
II. the second concentric ridge second angled surface being at an angle equal to, but opposite the first angled surface such that the first angled surface and second angled surface extend towards one another and meet at a second concentric ridge peak,
D. a third concentric ridge,
I. the third concentric ridge having a first angled surface and a second angled surface,
a. the third concentric ridge first angled surface being at an angle of approximately 60 degrees relative to the center axis, angling away from the center axis,
b. the third concentric ridge second angled surface being at an angle opposite the first angled surface such that the first angled surface and second angled surface extend towards one another and meet at a second concentric ridge peak, the third concentric ridge second angled surface being at an angle of approximately 50 degrees.

7. A compressed gas cylinder valve seal according to claim 1, further comprising;
A. a center axis,
B. the first concentric ridge having a first angled surface and a second angled surface,
I. the first angled surface being at an angle of approximately 50 degrees relative to the center axis, angled away from the center axis,
II. the second angled surface being at an angle equal to, but opposite the first angled surface such that the first angled surface and second angled surface extend towards one another and meet at a first concentric ridge peak.
C. a second concentric ridge,
I. the second concentric ridge having a first angled surface and a second angled surface,
a. the second concentric ridge first angled surface being at an angle of approximately 45 degrees relative to the center axis, angling away from the center axis,
b. the second concentric ridge second angled surface being at an angle equal to, but opposite the first angled surface such that the first angled surface and second angled surface extend towards one another and meet at a second concentric ridge peak,
D. a third concentric ridge,
I. the third concentric ridge having a first angled surface and a second angled surface,
a. the third concentric ridge first angled surface being at an angle of approximately 60 degrees relative to the center axis, angling away from the center axis,
b. the third concentric ridge second angled surface being at an angle opposite the first angled surface such that the first angled surface and second angled surface extend towards one another and meet at a third concentric ridge peak, the third concentric ridge second angled surface being at an angle of approximately 50 degrees.
E. a fourth concentric ridge,
I. the fourth concentric ridge having a first angled surface and a second angled surface,
a. the fourth concentric ridge first angled surface being at an angle of approximately 45 degrees relative to the center axis, angling away from the center axis,
b. the fourth concentric ridge second angled surface being at an angle equal to, but opposite the first angled surface such that the first angled surface and second angled surface extend towards one another and meet at a fourth concentric ridge peak.

8. A compressed gas cylinder valve seal according to claim 7, further comprising;
A. the second concentric ridge being located on the top surface,
B. the third concentric ridge being located on the bottom surface,
C. the fourth concentric ridge being located on the bottom surface.

9. A compressed gas cylinder valve seal according to claim 1, further comprising;
A. An opposite cylindrical center section ridge,
I. The cylindrical center section ridge and the opposite cylindrical center section ridge being spaced apart from one another by approximately 0.295 inch.
